(19) United States
(12) Patent Application Publication
(10) Pub. No.: US 2014/0307646 A1
(43) Pub. Date: Oct. 16, 2014

(54) ENHANCED ANTENNA MANAGEMENT FOR UPLINK OPERATION UNDER CARRIER AGGREGATION IN LTE

(71) Applicant: QUALCOMM Incorporated, San Diego, CA (US)

(72) Inventors: Wanshi Chen, San Diego, CA (US); Peter Gaal, San Diego, CA (US)

(73) Assignee: QUALCOMM Incorporated, San Diego, CA (US)

(21) Appl. No.: 14/228,785

(22) Filed: Mar. 28, 2014

Related U.S. Application Data
(60) Provisional application No. 61/812,629, filed on Apr. 16, 2013.

(51) Int. Cl. H04W 72/02

(52) U.S. Cl. CPC H04W 72/02
USPC 370/329

(57) ABSTRACT

A method of wireless communications includes configuring, by a user equipment (UE), uplink (UL) transmissions on one or more UL component carriers (CCs) by assigning one or more UE transmit antennas to each of the one or more CCs as a function of the number of UL CCs simultaneously involved in the UL transmissions. The method additionally includes transmitting the UL transmissions on the configured one or more CCs. In other aspects, a method of wireless communications includes scheduling, by a base station and for a UE, UL transmissions on one or more CCs based on a number of UL transmit antennas of the UE and as a function of a number of UL CCs simultaneously involved in the UL transmissions. The method additionally includes receiving at least one of the UL transmissions on at least one of the scheduled one or more CCs.

### CROSS-REFERENCE TO RELATED APPLICATIONS

This application claims the benefit of U.S. Provisional Patent Application No. 61/812,629, entitled, “ENHANCED ANTENNA MANAGEMENT FOR UPLINK OPERATION UNDER CARRIER AGGREGATION IN LTE”, filed on Apr. 16, 2013, which is expressly incorporated by reference herein in its entirety.

### BACKGROUND

1. Field

Aspects of the present disclosure relate generally to wireless communication systems, and more particularly, to antenna management for uplink operation under carrier aggregation in Long Term Evolution (LTE).

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of eNodeBs that can support communication for a number of user equipments (UEs). A UE may communicate with an eNodeB via the downlink and uplink. The downlink (or forward link) refers to the communication link from the eNodeB to the UE, and the uplink (or reverse link) refers to the communication link from the UE to the eNodeB.

LTE-Advanced (LTE-A) UEs use spectrum up to 20 MHz bandwidths allocated in a carrier aggregation of up to a total of 100 MHz (5 component carriers) used for transmission in each direction. Generally, less traffic is transmitted on the uplink than the downlink, so the uplink spectrum allocation may be smaller than the downlink allocation. For example, if 20 MHz is assigned to the uplink, the downlink may be assigned 100 MHz. These asymmetric frequency division duplex (FDD) assignments will conserve spectrum and are a good fit for the typically asymmetric bandwidth utilization by broadband subscribers.

For the LTE-A mobile systems, two types of carrier aggregation (CA) methods have been proposed, continuous CA and non-continuous CA. Non-continuous CA occurs when multiple available component carriers are separated along the frequency band. On the other hand, continuous CA occurs when multiple available component carriers are adjacent to each other. Both non-continuous and continuous CA aggregate multiple LTE/component carriers to serve a single unit of LTE-A UE.

A UE operating in CA may be configured to aggregate certain functions of multiple carriers, such as control and feedback functions, on the same carrier, which may be referred to as a “primary component carrier” (PCC). The network entities, eNBs, access points, and the like that communicate with a UE using the primary component carrier are referred to as “primary cells” or “PCells.” The remaining carriers that depend on the primary carrier for support may be referred to as “secondary component carriers” (SCCs). The network entities, eNBs, access points, and the like that communicate with a UE using the secondary component carriers may be referred to as “secondary cells” or “SCells.” For example, the UE may aggregate control functions such as those provided by the optional dedicated channel (DCH), the nonscheduled grants, a physical uplink control channel (PUCCH), and/or a physical downlink control channel (PDCCH). Signaling and payload may be transmitted both on the downlink by the eNB to the UE, and on the uplink by the UE to the eNB.

In a typical arrangement, one component carrier (CC) may be designated as a PCC, while all others are designated as SCCs. Additionally, the primary component carrier may be semi-statically configured by higher layers on a per UE basis. Also, acknowledgements and/or non-acknowledgements (ACK/NAK), channel quality indicator (CQI), and sounding reference signals (SRS), when transmitted on PUCCH, may be transmitted on the PCC, but not on an SCC. However, in alternative arrangements, it is possible that PUCCH may be transmitted on one or more SCCs as well. Such an alternative arrangement may be desirable, for example, when two or more cells in carrier aggregation are not co-located, and when the backhaul between those two cells is less than ideal. For example, the backhaul may be experiencing some delay or other limitations in the background that prevent effective use of the PCC for carrying ACK/NAK. It is envisioned that up to a five downlink (DL) CC to one uplink (UL) CC mapping may be implemented. In such an implementation, one UL CC may support ACK/NAK transmission on PUCCH for up to five downlink component carriers.

For UL operation, an SRS may be useful in many ways. For example, an SRS may be used for UL link adaptation. Additionally, an SRS may be used for DL scheduling under channel reciprocity, especially for time division duplex (TDD) systems. Also, an SRS may be used for coordinated multipoint (CoMP) operations. In a typical implementation, an SRS may be either periodic or aperiodic.

In LTE, a typical UE is equipped with one or more transmit antennas, making it possible to support UL multiple-input multiple-output (MIMO) operation. In this case, for a physical uplink shared channel (PUSCH), up to rank four transmissions are possible. Additionally, for PUCCH, transmit diversity with two antennas is possible.

In UL CA, there are several possible combinations involving PUCCH, PUSCH, SRS, and physical random access channel (PRACH) transmissions. For example, PUCCH may be transmitted on one carrier, and PUSCH may be transmitted on another carrier. Additionally, PUCCH and PUSCH may each, individually be transmitted on multiple carriers. Further, PUCCH/PUSCH may be transmitted on one carrier, and SRS may be transmitted on another carrier. Still further, SRS may be transmitted on multiple carriers. Finally, PRACH may be transmitted on one carrier, and PUCCH/PUSCH/SRS may be transmitted on another carrier.

### SUMMARY

Techniques for antenna management for uplink operation under carrier aggregation in LTE are described herein.

In an aspect, a method of wireless communications includes configuring, by a UE, UL transmissions on one or more UL component carriers CCs by assigning one or more UE transmit antennas to each of the one or more CCs as a function of the number of UL CCs simultaneously involved in the UL transmissions. The method additionally includes transmitting the UL transmissions on the configured one or more CCs.

In another aspect, a method of wireless communications includes scheduling, by a base station and for a UE, UL transmissions on one or more CCs based on a number of UL transmit antennas of the UE and as a function of a number of UL CCs simultaneously involved in the UL transmissions. The method additionally includes receiving at least one of the UL transmissions on at least one of the scheduled one or more CCs.

In an additional aspect, an apparatus for performing wireless communications includes means for configuring, by a UE, UL transmissions on one or more UL CCs by assigning one or more UE transmit antennas to each of the one or more CCs as a function of the number of UL CCs simultaneously involved in the UL transmissions. The apparatus additionally includes means for transmitting the UL transmissions on the configured one or more CCs.

In a further aspect, an apparatus for performing wireless communications includes means for scheduling, by a base station and for a UE, UL transmissions on one or more CCs based on a number of UL transmit antennas of the UE and as a function of a number of UL CCs simultaneously involved in the UL transmissions. The apparatus additionally includes means for receiving at least one of the UL transmissions on at least one of the scheduled one or more CCs.

In another aspect, a computer-program product includes a computer-readable medium. The computer-readable medium includes code for configuring, by a UE, UL transmissions on one or more UL CCs by assigning one or more UE transmit antennas to each of the one or more CCs as a function of the number of UL CCs simultaneously involved in the UL transmissions. The computer-readable medium additionally includes code for transmitting the UL transmissions on the configured one or more CCs.

In an additional aspect, a computer-program product includes a computer-readable medium. The computer-readable medium includes code for scheduling, by a base station and for a UE, UL transmissions on one or more CCs based on a number of UL transmit antennas of the UE and as a function of a number of UL CCs simultaneously involved in the UL transmissions. The computer-readable medium additionally includes code for receiving at least one of the UL transmissions on at least one of the scheduled one or more CCs.

In a further aspect, a UE configured for wireless communication includes at least one processor and a memory coupled to the at least one processor. The at least one processor is configured to configure, by the UE, UL transmissions on one or more UL CCs by assigning one or more UE transmit antennas to each of the one or more CCs as a function of the number of UL CCs simultaneously involved in the UL transmissions. The at least one processor is additionally configured to transmit the UL transmissions on the configured one or more CCs.

In another aspect, a base station configured for wireless communication includes at least one processor and a memory coupled to the at least one processor. The at least one processor is configured to schedule, for a UE, UL transmissions on one or more CCs based on a number of UL transmit antennas of the UE and as a function of a number of UL CCs simultaneously involved in the UL transmissions. The at least one processor is additionally configured to receive at least one of the UL transmissions on at least one of the scheduled one or more CCs.

In an additional aspect of the disclosure, a method of wireless communications includes determining, by a UE, a downlink control information (DCI) message size for monitoring by the UE, wherein the DCI message size is determined based on a first set of transmit antennas, determining, by the UE, a second set of transmit antennas for at least one uplink transmission; and transmitting the at least one uplink transmission on at least one uplink CC using the second set of transmit antennas.

In an additional aspect of the disclosure, an apparatus configured for wireless communications includes means for determining, by a UE, a DCI message size for monitoring by the UE, wherein the DCI message size is determined based on a first set of transmit antennas, means for determining, by the UE, a second set of transmit antennas for at least one uplink transmission; and means for transmitting the at least one uplink transmission on at least one uplink CC using the second set of transmit antennas.

In an additional aspect of the disclosure, a computer program product has a computer-readable medium having program code recorded thereon. This program code includes code to determine, by a UE, a DCI message size for monitoring by the UE, wherein the DCI message size is determined based on a first set of transmit antennas, code to determine, by the UE, a second set of transmit antennas for at least one uplink transmission; and code to transmit the at least one uplink transmission on at least one uplink CC using the second set of transmit antennas.

In an additional aspect of the disclosure, an apparatus includes at least one processor and a memory coupled to the processor. The processor is configured to determine, by a UE, a DCI message size for monitoring by the UE, wherein the DCI message size is determined based on a first set of transmit antennas, to determine, by the UE, a second set of transmit antennas for at least one uplink transmission; and to transmit the at least one uplink transmission on at least one uplink CC using the second set of transmit antennas.

Various aspects and features of the disclosure are described in further detail below.

### BRIEF DESCRIPTION OF THE DRAWINGS

FIG. 1 is a block diagram illustrating an example of a telecommunications system;

FIG. 2 is a block diagram illustrating an example of a down link frame structure in a telecommunications system;

FIG. 3 is a block diagram illustrating a design of an eNodeB and a UE configured according to one aspect of the present disclosure;

FIG. 4 is a block diagram illustrating UL CC transmission subframes in an antenna management scenario in which a UE having N UL transmit antennas and configured with M UL CCs indicates no more than N/M transmit antennas to an eNodeB for UL operation;

FIG. 5 is a block diagram illustrating UL CC transmission subframes in an antenna management scenario in which a UE is capable of dynamically managing UL transmit antennas and transmits UL transmissions on an UL CC based on a number of UL transmit antennas and as a function of a number of UL CCs simultaneously involved in the UL transmissions;

FIG. 6 is a block diagram illustrating example blocks of a wireless communication process carried out by a UE capable of dynamically managing UL transmit antennas and transmitting UL transmissions on tan UL CC based on a number of UL transmit antennas and as a function of a number of UL CCs simultaneously involved in the UL transmissions;

FIG. 7 is a block diagram illustrating example blocks of a wireless communication process carried out by a base station scheduling, for a UE capable of dynamically managing UL transmit antennas, UL transmissions on a UL CC based on a number of UL transmit antennas of the UE and as a function of a number of UI. CCs simultaneously involved in the UL transmissions;

FIG. 8 is a graphical illustration of an example precoding matrix indicator (PMI) encoding that minimizes mismatch in case of missed grants for LTE Release 10 Rank 1 two transmitter and four transmitter codebooks; and

FIG. 9 is a graphical illustration of an example PMI encoding that minimizes mismatch in case of missed grants for LTE Release 10 Rank 2 two transmitter and four transmitter codebooks.

FIG. 10 is a block diagram illustrating example blocks of a wireless communication process carried out by a user equipment to implement one aspect of the present disclosure.

### DETAILED DESCRIPTION

The detailed description set forth below, in connection with the appended drawings, is intended as a description of various configurations and is not intended to represent the only configurations which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA. TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

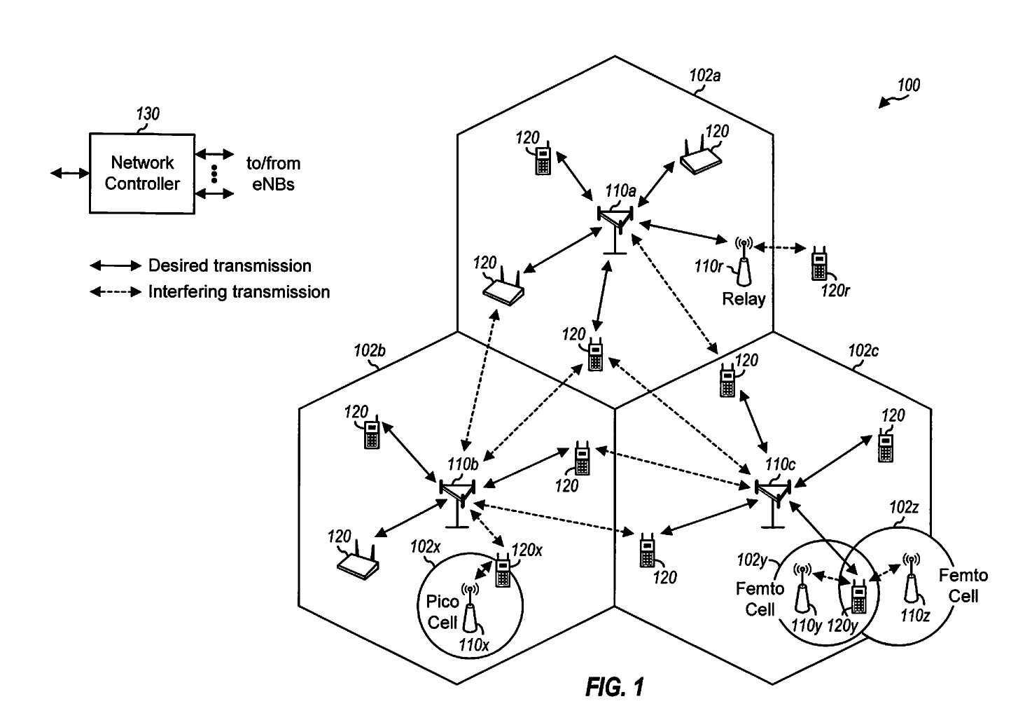

FIG. 1 shows a wireless communication network 100, which may be an LTE network. The wireless network 100 may include a number of evolved Node Bs (eNodeBs) 110 and other network entities. An eNodeB may be a station that communicates with the UEs and may also be referred to as a base station, an access point, etc. A Node B is another example of a station that communicates with the UEs.

Each eNodeB 110 may provide communication coverage for a particular geographic area. In 3GPP, the term “cell” can refer to a coverage area of an eNodeB and/or an eNodeB subsystem serving this coverage area, depending on the context in which the term is used.

An eNodeB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNodeB for a macro cell may be referred to as a macro eNodeB. An eNodeB for a pico cell may be referred to as a pico eNodeB. An eNodeB for a femto cell may be referred to as a femto eNodeB or a home eNodeB. In the example shown in FIG. 1, the eNodeBs 110a, 110b and 110c may be macro eNodeBs for the macro cells 102a, 102b and 102c, respectively. The eNodeB 110x may be a pico eNodeB for a pico cell 102x serving a UE 120x. The eNodeBs 110y and 110z may be femto eNodeBs for the femto cells 102y and 102z, respectively. An eNodeB may support one or multiple (e.g., three) cells.

The wireless network 100 may also include relay stations. A relay station is a station that receives a transmission of data and/or other information from an upstream station (e.g., an eNodeB or a UE) and sends a transmission of the data and/or other information to a downstream station (e.g., a UE or an eNodeB). A relay station may also be a UE that relays transmissions for other UEs. In the example shown in FIG. 1, a relay station 110r may communicate with the eNodeB 110a and a UE 120r in order to facilitate communication between the eNodeB 110a and the UE 120r. A relay station may also be referred to as a relay eNodeB, a relay, etc.

The wireless network 100 may be a heterogeneous network that includes eNodeBs of different types, e.g., macro eNodeBs, pico eNodeBs, femto eNodeBs, relays, etc. These different types of eNodeBs may have different transmit power levels, different coverage areas, and different impact on interference in the wireless network 100. For example, macro eNodeBs may have a high transmit power level (e.g., 20 Watts) whereas pico eNodeBs, femto eNodeBs and relays may have a lower transmit power level (e.g., 1 Watt).

The wireless network 100 may support synchronous or asynchronous operation. For synchronous operation, the eNodeBs may have similar frame timing, and transmissions from different eNodeBs may be approximately aligned in time. For asynchronous operation, the eNodeBs may have different frame timing, and transmissions from different eNodeBs may not be aligned in time. The techniques described herein may be used for both synchronous and asynchronous operation.

A network controller 130 may couple to a set of eNodeBs and provide coordination and control for these eNodeBs. The network controller 130 may communicate with the eNodeBs 110 via a backhaul. The eNodeBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a smart phone, a handheld device, a laptop computer, a cordless phone, a wireless local loop (WLL) station, etc. A UE may be able to communicate with macro eNodeBs, pico eNodeBs, femto eNodeBs, relays, etc. In FIG. 1, a solid line with double arrows indicates desired transmissions between a UE and a serving eNodeB, which is an eNodeB designated to serve the UE on the downlink and/or uplink. A dashed line with double arrows indicates interfering transmissions between a UE and an eNodeB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

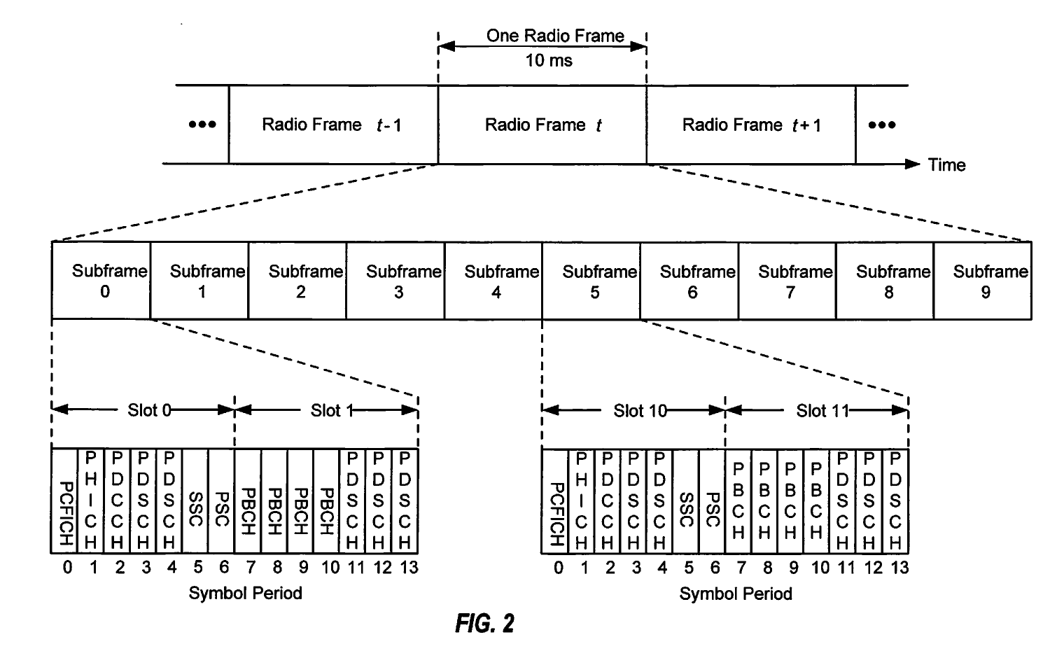

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 2) or 6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNodeB may send a primary synchronization signal (PSS) and a secondary synchronization signal (SSS) for each cell in the eNodeB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNodeB may send a Physical Broadcast Channel (PBCH) in symbol periods 0 to 3 in slot 1 of subframe 0. The PBCH may carry certain system information.

The eNodeB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNodeB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on uplink and downlink resource allocation for UEs and power control information for uplink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNodeB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNodeB may send the PSS, SSS and PBCH in the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to specific UEs in specific portions of the system bandwidth. The eNodeB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNodeB may send the PDCCH to the UE in any of the combinations that the UE will search.

A UE may be within the coverage of multiple eNodeBs. One of these eNodeBs may be selected to serve the UE. The serving eNodeB may be selected based on various criteria such as received power, path loss, signal-to-noise ratio (SNR), etc.

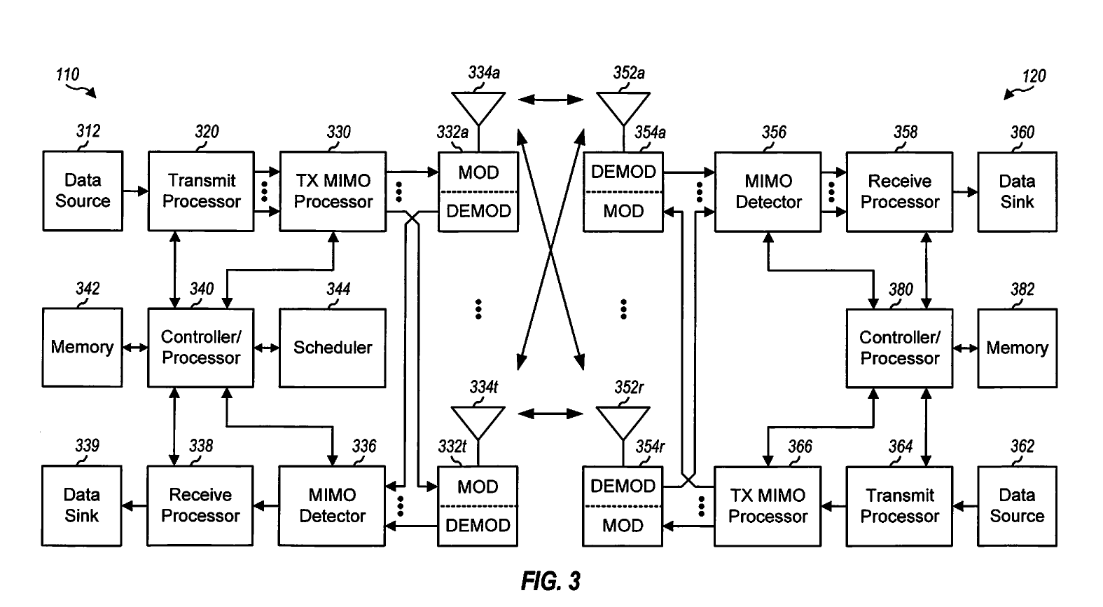

FIG. 3 shows a block diagram of a design of an eNodeB 110 and a UE 120, which may be one of the eNodeBs and one of the UEs in FIG. 1. For a restricted association scenario, the eNodeB 110 may be the macro eNodeB 110c in FIG. 1, and the UE 120 may be the UE 120y. The eNodeB 110 may be equipped with antennas 334a through 334t, and the UE 120 may be equipped with antennas 352a through 352r.

At the eNodeB 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TRANSMIT) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the eNodeB 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from the transmit processor 364 may be precoded by a transmit MIMO processor 366 if applicable, further processed by the modulators 354a through 354r (e.g., for SC-FDM, etc.), and transmitted to the eNodeB 110. At the eNodeB 110, the uplink signals from the UE 120 may be received by the antennas 334, processed by the demodulators 332a through 332t, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

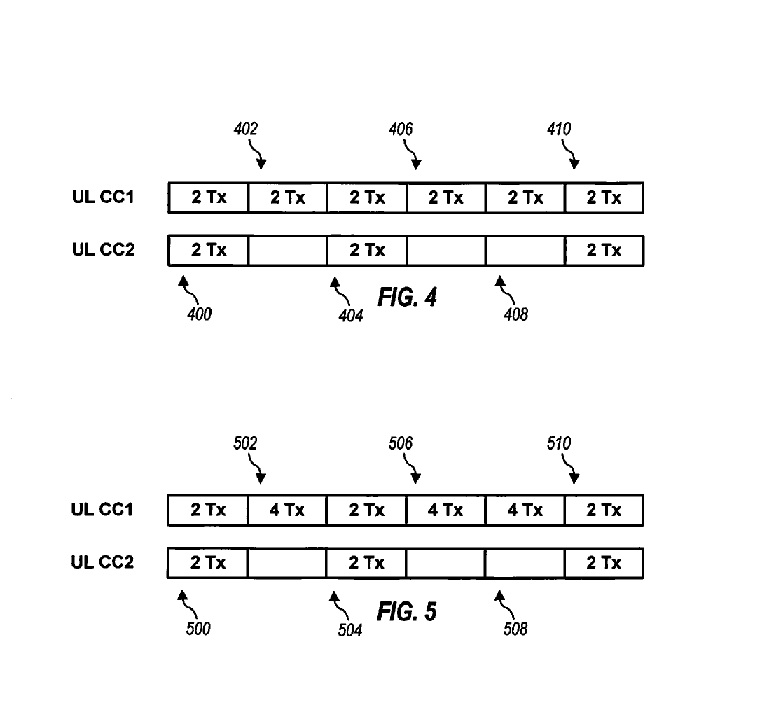

The controllers/processors 340 and 380 may direct the operation at the eNodeB 110 and the UE 120, respectively. The processor 340 and/or other processors and modules at the eNodeB 110 may perform or direct the execution of various processes for the techniques described herein. The processor 380 and/or other processors and modules at the UE 120 may also perform or direct the execution of the functional blocks illustrated in FIGS. 4-8, and/or other processes for the techniques described herein. The memories 342 and 382 may store data and program codes for the eNodeB 110 and the UE 120, respectively. A scheduler 344 may schedule UEs for data transmission on the downlink and/or uplink.

An issue that arises in UL CA involves use of a UE's transmit antennas. For example, FIG. 4 shows UL CC transmission subframes 400-410 in an antenna management scenario in which a UE having N UL transmit antennas and configured with M UL CCs allocates no more than N/M transmit antennas to an UL CC (or corresponding eNodeB). For example, if a UE has four transmit antennas and is configured for two UL CCs, then two transmit antennas may be allocated to each of the two CCs. The two CCS may be of a same band or different bands. This option for UL transmit antenna management, however, may suffer from inefficiency, especially in subframes 402, 406, and 408 for which one of the CCs is inactive. In these subframes 402, 406, and 408, the UE transmits on only a subset of the UL CCs, and one or more of the transmit antennas may not be utilized. In the aforementioned example involving the UE having four transmit antennas and configured with two CCs, two of the transmit antennas remain unutilized in a subframe in which one of the CCs is inactive.

In another implementation, a UE may dynamically manage UL transmit antenna assignments to UL CCs based on the number of UL CCs simultaneously involved in the UL transmissions. FIG. 5 shows UL CC transmission subframes 500-510 in an antenna management scenario in which a UE is capable of dynamically managing UL transmit antennas. The UE transmits UL transmissions using a number of transmit antennas per UL CC based on the number of UL transmit antennas as a function of the number of UL CCs simultaneously involved in the UL transmissions. With this arrangement, the transmit antennas may be allocated to the component carriers dynamically and on a subframe-by-subframe basis. Accordingly, in another example in which a UE has four transmit antennas and is configured with two UL CCs, all four of the transmit antennas may be utilized in each subframe, including those subframes in which one of the CCs is inactive. In this case, one of the CCs may be transmitted utilizing all four transmit antennas in every subframe in which the other CC is inactive. In other configurations, more than two CCs and more or fewer than four transmit antennas may be simultaneously involved in the UL transmissions.

Dynamic antenna management may provide numerous benefits relating to the increased utilization of UL transmit antennas enabling a UL CC to better perform MIMO operations. For example, the increased utilization of UL transmit antennas may provide improved PUCCH transmit diversity. Additionally, the increased utilization of UL transmit antennas may provide for enhanced UL beamforming. Also, the increased utilization of UL transmit antennas may provide for enhanced multi user MIMO (MU-MIMO) operation, in terms of both greater likelihood of MU-MIMO operation, and improved MU-MIMO performance. Further, the increased utilization of UL transmit antennas may provide for enhanced single user MIMO (SU-MIMO) operation by making possible a higher rank SU-MIMO operation.

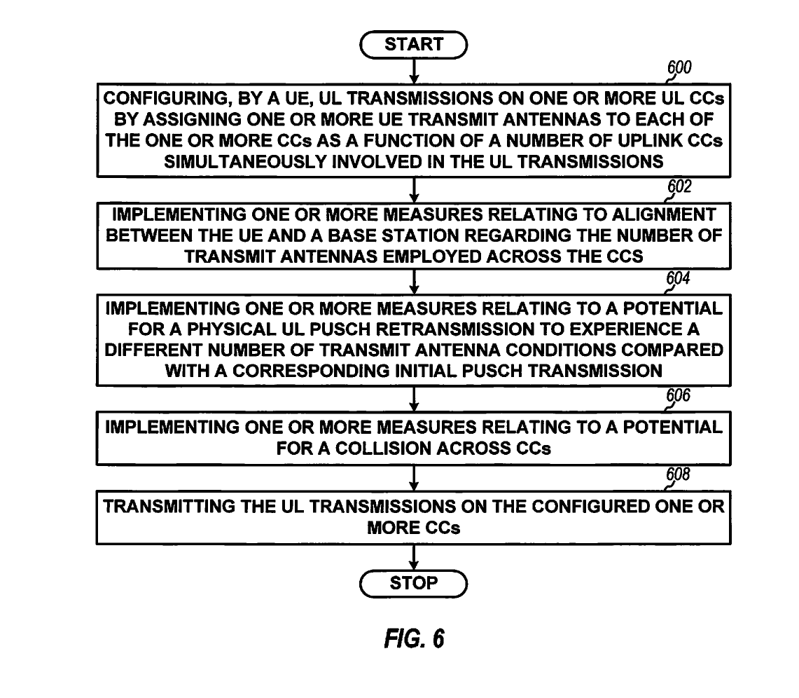

In a dynamic antenna management implementation, a UE and a base station may have different roles with respect to antenna alignment regarding the number of transmit antennas allocated to the CCs as a function of what is being transmitted on the CCs at any given time. For example, a UE capable of dynamically managing UL transmit antennas may transmit UL transmissions on an UL CC based on a number of UL transmit antennas and as a function of a number of UL CCs simultaneously involved in the UL transmissions. Additionally, a base station may schedule, for a UE capable of dynamically managing UL transmit antennas, UL transmissions on a UL CC based on a number of UL transmit antennas of the UE and as a function of a number of UL CCs simultaneously involved in the UL transmissions. For the dynamic antenna management implementation to be more effective, it is advantageous for the UE and the base station to be aligned with respect to the number of transmit antennas used for UL transmissions on a CC in a given subframe. Therefore, the UE and/or the base station may additionally implement one or more measures relating to dynamic antenna alignment across CCs, between the UE and a base station, regarding the number of transmit antennas employed across the CCs. A base station may also implement further measures relating to other complications that may arise with the dynamic antenna management techniques described herein. These options and alternatives are described in greater detail below with respect to FIGS. 6-10.

FIG. 6 shows example blocks of a wireless communication process carried out by a UE capable of dynamically managing UL transmit antennas. At block 600, the UE configures UL transmissions on one or more UL CCs by assigning one or more UE transmit antennas to each of the one or more CCs as a function of a number of uplink CCs simultaneously involved in the UL transmissions. For example, the UE may, for each subframe, seek to allocate the transmit antennas by the number of active UL CCs in the respective sub-frame. If the number of transmit antennas does not divide evenly by the number of active UL CCs, the UE may apply a floor function to the result. Any unutilized antennas may remain unutilized, may be allocated to a primary CC, may be allocated randomly to a CC, may be allocated to a CC based on need (e.g. to a CC carrying out retransmission for which the initial transmission utilized a larger number of transmit antennas), etc. At block 600, the UL transmissions may include PUCCH transmissions, SRS transmissions, and/or PUSCH transmissions. Processing may proceed from block 600 to block 602.

At block 602, the UE may implement one or more measures relating to alignment between the UE and a base station regarding the number of transmit antennas employed across the CCs. For example, the one or more measures relating to alignment may include communicating with the base station based on a number of activated component carriers for the UE. In this example, the UE may utilize all of the antennas if only one CC is activated, but then operate, as shown in FIG. 4, when a second CC is activated. This example benefits from ease of alignment between the UE and the base station. However, because the activation/deactivation of the second CC cannot be performed on a subframe-by-subframe basis, this alternative may suffer from inefficiency as described above.

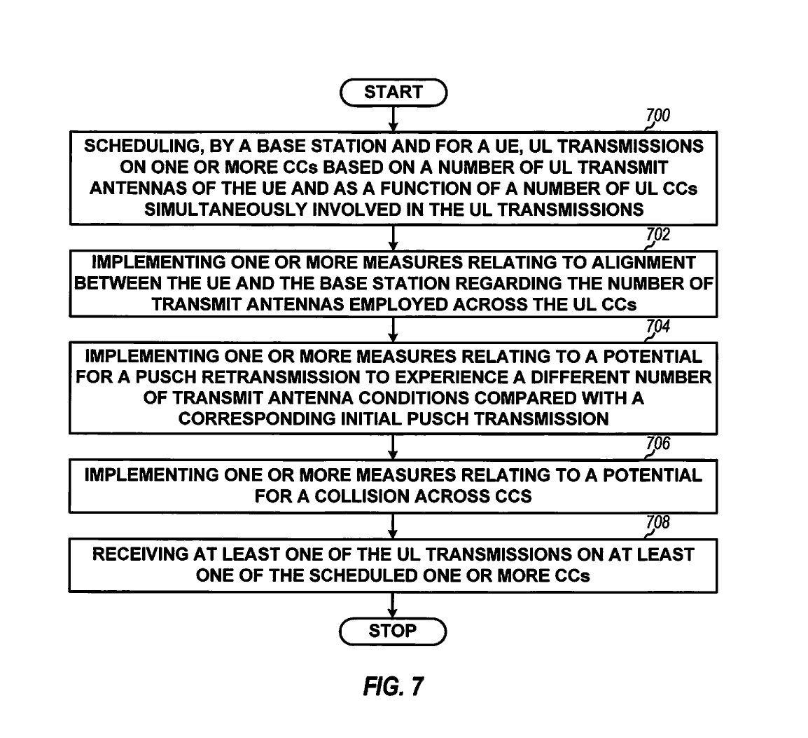

Another alternative, at block 602, is for the UE to receive, from the base station, information about a number of transmit ports for the uplink transmission. It is envisioned that the UE may receive this information using downlink control information (DCI), by receiving a cyclic redundancy check (CRC) mask selected by the base station based on the number of transmit ports, and/or by receiving a subframe index selected, by the base station, based on the number of transmit ports. As explained further below with reference to FIG. 7, it is additionally envisioned that the UE may receive a number of transmit ports explicitly or implicitly via information in the DCI. The number of transmit ports may be explicitly received in the DCI by setting one or more bits in the DCI. For example, a UE may be configured to use either two or four transmit antennas for UL transmissions. One bit in the DCI may be used to indicate whether two transmit antennas (ports) or four transmit antennas (ports) should be used for the transmission, e.g., a PUSCH transmission. This signaling of using either two or four transmit antennas for UL transmissions may be provided semi-statically via the radio-resource control (RRC) layer from the base station, such that the DCI bit will set the number of transmit antennas (ports), which will remain set until the bit in a subsequent DCI changes. Note that the DCI size is dependent on the number of transmit ports. As an example, in DCI format 4, an information field named precoding information has 6 bits for the case of 4 transmit antennas and 3 bits for the case of 2 transmit antennas. In order to avoid increasing the maximum number of blind decodes, the DCI size may be based on a size of the maximum number of transmit ports, e.g., four transmit ports. As an example, the information field of precoding information in DCI format 4 can always be assumed as 6 bits. Alternatively, a limited number of DCI sizes may be identified based on different numbers of transmit ports. As an example, two possible DCI format 4 sizes may be determined, one based on a 3-bit precoding information field and the other based on a 6-bit precoding information field. Alternatively, the DCI may be used to implicitly communicate the number of transmission ports for a transmission. For example, a UE may be configured for two or four transmit port transmissions on a CC. The starting control channel element (CCE) of the DCI transmission can be used to implicitly communicate whether two transmit ports or four transmit ports should be used for the transmission, e.g., a PUSCH transmission. An odd starting CCE may imply two transmit ports while an even starting CCE may imply four transmit ports.

An additional alternative, at block 602, is for the UE to determine a number of transmit ports based on a number of UL CCs involved in uplink transmissions (e.g., a number of configured PUSCH transmissions on the uplink, a number of configured SRS transmissions, a combined number of configured PUCCH and PUSCH transmissions, etc.) For example, if a UE has four transmit antennas and is configured with two UL CCs, then four transmit antennas may be used if one PUSCH transmission is configured, and two transmit antennas may be used per UL CC if two PUSCH transmissions are configured. In this example, since the DCI size depends on the number of transmit ports, the DCI size is preferably based on the four transmit port scenario in order to avoid increasing the maximum number of blind decodes. In this alternative, the UE may additionally alleviate potential misalignments resulting from the UE missing one or more PDCCH transmissions. Toward this end, the UE may assume 6-bit precoding information in a received DCI, and codebook entries for 3-bit precoding are arranged such that a precoding vector for a higher number of antennas is equivalent or close to a corresponding precoding vector for a lower number of antennas. Additional details relating to this design are described further below with reference to FIGS. 7-10. Processing may proceed from block 602 to block 604.

At block 604, the UE may implement one or more measures relating to a potential for a PUSCH retransmission to experience a different number of transmit antenna conditions compared with a corresponding initial PUSCH transmission. For example, the UE may treat such a PUSCH retransmission as an error case, and, thus, rely on an eNodeB scheduling operation to ensure that such transitions do not happen. Alternatively, the UE may select a number of transmit antennas for a PUSCH retransmission to be the same as for the corresponding initial PUSCH transmission. This selection is possible for retransmissions that have the same or a greater number of transmit antennas compared to the initial PUSCH transmissions. It is envisioned that, in the case of retransmissions having less transmit antennas than the initial PUSCH transmissions, two physical transmit antennas may be mapped to four virtual antennas ports, but this option is not presently preferred due to poor performance. As another alternative, the UE may select a number of transmit antennas for a PUSCH retransmission to be the same as a most recent PUSCH transmission. In this alternative, using a greater number of transmit antennas for a PUSCH retransmission compared to the original PUSCH transmission generally creates no issues. Similarly, there are also generally no issues resulting from using a lesser number of antennas so long as the initial PUSCH transmission rank is either rank 1 or rank 2. However, for initial PUSCH transmissions of higher rank (e.g., rank 3 or rank 4), this alternative may still be utilized by assuming that only the first transport block of the two transport blocks in the initial transmission is retransmitted. Therefore, for a rank greater than two, the UE and/or base station may assume that only a first transport block of two transport blocks in the corresponding initial PUSCH transmission is included in the PUSCH retransmission. Processing may proceed from block 604 to block 606.

At block 606, the UE may further implement one or more measures relating to a potential for a collision across CCs. For example, the UE may implement measures relating to a collision across CCs between a PUCCH transmission and a PUSCH transmission. Additionally, the UE may implement measures relating to a collision across CCs between a PUSCH transmission and a SRS transmission. Also, the UE may implement measures relating to a collision across CCs between one SRS transmission and another SRS transmission. Further, the UE may implement measures relating to a collision across CCs between one PUCCH transmission and another PUCCH transmission. Yet further, the UE may implement measures relating to a collision across CCs between a PRACH transmission and a PUCCH transmission, an SRS transmission, and/or a PUSCH transmission.

In the case of a collision between PUCCH and PUSCH across CCs, the UE may disable parallel PUCCH transmission and PUSCH transmission across component carriers. In this case, the UE may piggyback uplink control information (UCI) on PUSCH transmissions. Additionally or alternatively, the UE may allow parallel PUCCH transmission and PUSCH transmission across CCs. In this case, the UE may split a transmit antenna between PUCCH transmission and PUSCH transmission.

In the case of a collision between PUSCH and SRS across CCs, the UE may determine whether combined transmit antennas for SRS transmission and PUSCH transmission can be supported. In response to a determination that combined transmit antennas for SRS transmission and PUSCH transmission cannot be supported, the UE may drop either the PUSCH transmission or the SRS transmission. As another alternative, the UE may disallow parallel SRS transmission and PUSCH transmission across CCs when the number of antenna ports requested by parallel SRS transmissions exceeds the number of available antennas at the UE.

In the case of a collision between one SRS transmission and another SRS transmission across CCs, and when the number of antenna ports requested by parallel SRS transmissions exceeds the number of available antennas at the UE, the UE may determine which of the SRS transmissions has priority. In this case, the UE may transmit whichever of the SRS transmissions has the priority, while avoiding (e.g., preventing or delaying) transmission of the SRS transmission that does not have the priority. For example, the UE may give an aperiodic SRS transmission higher priority than a periodic SRS transmission. Additionally, the UE may give an SRS transmission on a primary CC a higher priority than an SRS transmission on a secondary CC. As an alternative, the UE may split the transmit antennas across the CCs. Such splitting of transmit antennas may be preferred for frequent SRS transmission collisions, and/or for colliding SRS transmissions that are both periodic. As another alternative, the UE may treat the collision as an error configuration.

In the case of a collision between PUCCH transmissions across CCs, the UE may simply disallow parallel PUCCH transmission across CCs. Alternatively, the UE may permit the base station to implement its own measures for handling or avoiding such collisions.

In the case of a collision between a PRACH transmission and either a PUCCH transmission, an SRS transmission, and/or a PUSCH transmission, the UE may utilize a number of transmit antennas per CC that is the same as for a UE that is not capable of dynamically managing UL transmit antennas. Processing may proceed from block 606 to block 608.

At block 608, the UE may transmit the UL transmissions to a one or more base stations on the configured CCs.

FIG. 7 shows example blocks of a wireless communication process carried out by a base station. At block 700, the base station schedules UL transmissions for a UE capable of dynamically managing UL transmit antennas. The base station schedules the UL transmissions on a UL CC based on a number of UL transmit antennas of the UE. The base station also schedules the UL transmissions on a UL CC as a function of a number of UL CCs simultaneously involved in the UL transmissions. For example, the base station may, for each subframe, seek to allocate the transmit antennas by the number of active UL CCs in the respective sub-frame. If the number of transmit antennas does not divide evenly by the number of active UL CCs, the base station may apply a floor function to the result. Any unutilized antennas may remain unutilized, may be allocated to a primary CC, may be allocated randomly to a CC, may be allocated to a CC based on need (e.g. to a CC carrying out retransmission for which the initial transmission utilized a larger number of transmit antennas), etc. At block 700, the UL transmissions may include PUCCH transmissions, SRS transmissions, and/or PUSCH transmissions. Processing may proceed from block 700 to block 702.

At block 702, the base station may implement one or more measures relating to alignment between the UE and a base station regarding the number of transmit antennas employed across the CCs. For example, the one or more measures relating to alignment may include scheduling transmit antennas based on a number of activated UL CCs for the UE. In this example, the base station may schedule the UE to utilize all of the antennas if only one CC is activated, but then operate as shown in FIG. 4 when a second CC is activated. This example benefits from ease of alignment between the UE and the base station. However, because the activation/deactivation of the second UL CC cannot be performed on a subframe-by-subframe basis, this alternative suffers from inefficiency as described above.

Another alternative, at block 702, is for the base station to communicate information to the UE about a number of transmit ports to be used for the UL transmission. It is envisioned that the base station may communicate this information using a DCI, by selecting a CRC mask based on the number of transmit ports, and/or by selecting a subframe index based on the number of transmit ports. As mentioned above with respect to FIG. 6, it is additionally envisioned that the base station may communicate the number of transmit ports explicitly in the DCI, or that the base station may use the DCI to implicitly communicate the number of transmission ports to the UE. For example, the base station may set one or more bits in the DCI to indicate the allocation of the transmit ports to the UL CCs. In this case, since the DCI size depends on the number of transmit ports, the DCI size may be based on the largest possible number of transmit antennas in order to avoid increasing the maximum number of blind decodes. Alternatively or additionally, the base station may select a starting CCE of DCI transmission to indicate the allocation of transmit ports to the UL CCs (e.g., odd for two transmit ports allocated per CC, even for four transmit ports allocated to the primary CC).

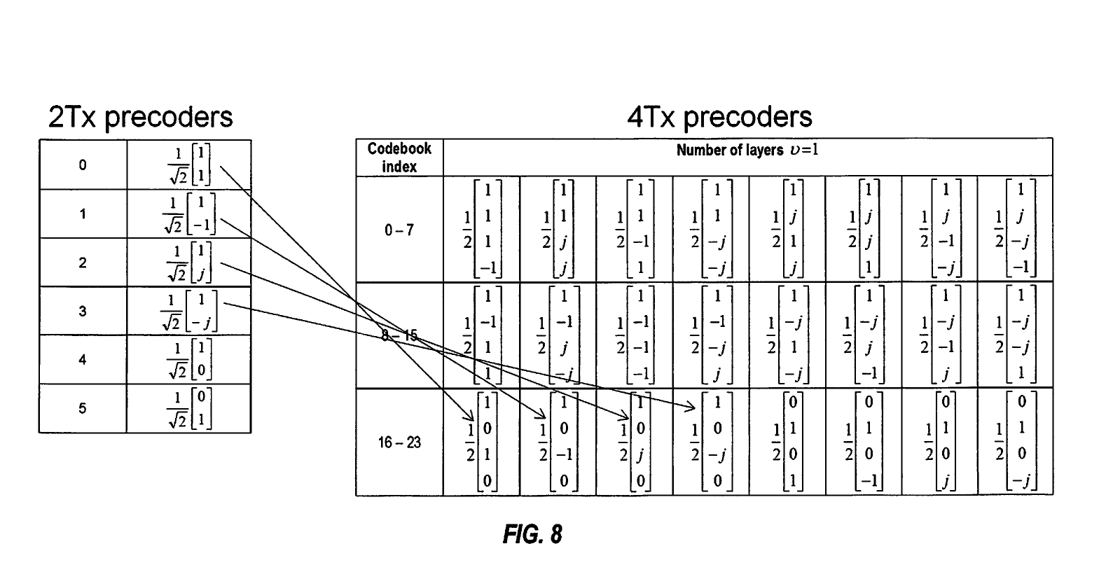

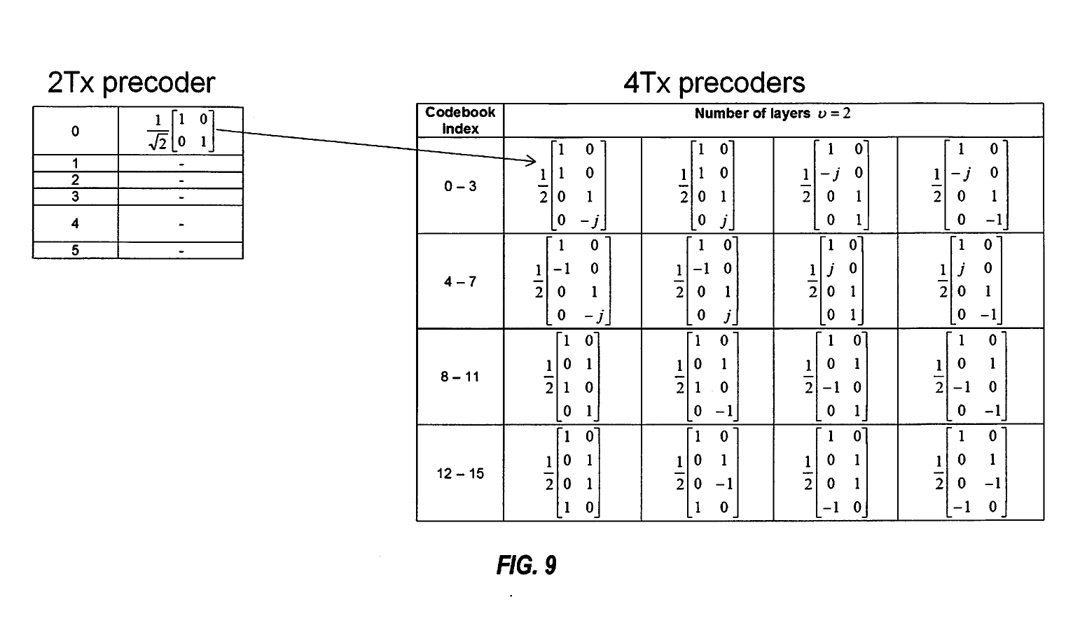

An additional alternative, at block 702, is for the base station to allocate a number of transmit ports based on a number of UL CCs involved in uplink transmissions (e.g., a number of detected PUSCH transmission on the uplink, a number of configured and/or detected SRS transmissions, a combination of detected PUCCH and PUSCH transmissions, etc.). For example, if a UE has four transmit antennas total and is configured with two UL CCs, then four transmit antennas may be allocated to the active UL CC if only one PUSCH transmission is detected, and two transmit antennas may be allocated per UL CC if two PUSCH transmissions are detected. In this example, since the DCI size depends on the number of transmit ports, the DCI size is preferably based on the four transmit port scenario in order to avoid increasing the maximum number of blind decodes. In this alternative, the base station may additionally alleviate potential misalignments resulting from the UE missing one or more PDCCH transmissions. Toward this end, the base station may employ a PMI design such that at least one codebook entry for a lower number of transmit antennas matches, or can be approximated by, a corresponding codebook entry for a larger number of transmit antennas. Example PMI designs are described below with reference to FIGS. 8 and 9.

FIG. 8 shows an example PMI encoding that minimizes mismatch in case of missed grants for LTE Release 10 Rank 1 two transmitter and four transmitter codebooks. In this example, the following 6-bit encoding of the Rank 1 two transmitter PMI may be used:
‘000’---->‘010000’;
‘001’---->‘010001’;
‘010’---->‘010010’;
‘011’---->‘010011’;
‘100’---->‘111110’ (reserved);
‘000’--->‘010000’ (reserved).

FIG. 9 shows an example PMI encoding that minimizes mismatch in case of missed grants for LTE Release 10 Rank 2 two transmitter and four transmitter codebooks. In this example, the following 6-bit encoding of the Rank 2 two transmitter PMI may be used:
‘000’--->‘00000’.
   Returning now to FIG. 7, processing may proceed from block 702 to block 704.

At block 704, the base station may implement one or more measures relating to a potential for a PUSCH retransmission to experience a different number of transmit antenna conditions compared with a corresponding initial PUSCH transmission. For example, the base station may treat such a PUSCH retransmission as an error case, and, thus, rely on an eNodeB scheduling operation to ensure that such transitions do not happen. Alternatively, the base station may select a number of transmit antennas for a PUSCH retransmission to be the same as for the corresponding initial PUSCH transmission. This selection is possible for retransmissions that have the same or a greater number of transmit antennas compared to the initial PUSCH transmissions. It is envisioned that, in the case of retransmissions having less transmit antennas than the initial PUSCH transmissions, two physical transmit antennas may be mapped to four virtual antennas ports. However, such a virtual mapping may result in performance loss due to loss of ACK/NAK or other data transmitted on the dropped carrier. As another alternative, the base station may select a number of transmit antennas for a PUSCH retransmission to be the same as that of a most recent PUSCH transmission. In this alternative, using a greater number of transmit antennas for a PUSCH retransmission compared to the original PUSCH transmission presents no issues with respect to the PUSCH retransmission. Similarly, there are also generally no issues resulting from using a lesser number of antennas so long as the initial PUSCH transmission rank is either rank 1 or rank 2. However, for initial PUSCH transmissions of higher rank (e.g., rank 3 or rank 4), this alternative may still be utilized by assuming that only the first transport block of the two transport blocks in the initial transmission is retransmitted. Therefore, for a rank greater than two, the base station may assume that only a first transport block of two transport blocks in the corresponding initial PUSCH transmission is included in the PUSCH retransmission. Processing may proceed from block 704 to block 706.

At block 706, the base station may further implement one or more measures relating to a potential for a collision across CCs. For example, the base station may implement measures relating to a collision across CCs between a PUCCH transmission and a PUSCH transmission. Additionally, the base station may implement measures relating to a collision across CCs between a PUSCH transmission and a SRS transmission. Also, the base station may implement measures relating to a collision across CCs between one SRS transmission and another SRS transmission. Further, the base station may implement measures relating to a collision across CCs between one PUCCH transmission and another PUCCH transmission. Yet further, the base station may implement measures relating to a collision across CCs between a PRACH transmission and a PUCCH transmission, an SRS transmission, and/or a PUSCH transmission.

In the case of a collision between PUCCH and PUSCH across CCs, the base station may disable parallel PUCCH transmission and PUSCH transmission across component carriers. In this case, the base station may receive uplink control information (UCI) piggybacked on PUSCH transmissions. Additionally or alternatively, the base station may allow parallel PUCCH transmission and PUSCH transmission across CCs. In this case, the base station may split a transmit antenna between PUCCH transmission and PUSCH transmission.

In the case of a collision between PUSCH and SRS across CCs, the base station may determine whether combined transmit antennas for SRS transmission and PUSCH transmission can be supported. In response to a determination that combined transmit antennas for SRS transmission and PUSCH transmission cannot be supported, the base station can drop either the PUSCH transmission or the SRS transmission. As another alternative, the base station may disallow parallel SRS transmission and PUSCH transmission across CCs when the number of antenna ports requested by parallel SRS transmissions exceeds the number of available antennas at the UE.

In the case of a collision between one SRS transmission and another SRS transmission across CCs and when the number of antenna ports requested by parallel SRS transmissions exceeds the number of available antennas at the UE, the base station may determine which of the SRS transmissions has priority. In this case, the base station may transmit whichever of the SRS transmissions has the priority, while avoiding (e.g., preventing or delaying) transmission of the SRS transmission that does not have the priority. For example, the base station may give an aperiodic SRS transmission higher priority than a periodic SRS transmission. Additionally, the base station may give an SRS transmission on a primary CC a higher priority than an SRS transmission on a secondary CC. As an alternative, the base station may split the transmit antennas across the CCs. Such splitting of transmit antennas may be preferred for frequent SRS transmission collisions, and/or for colliding SRS transmissions that are both periodic. As another alternative, the base station may treat the collision as an error configuration.

In the case of a collision between PUCCH transmissions across CCs, the base station may simply disallow parallel PUCCH transmission across CCs. Alternatively, the base station may permit the UE to implement its own measures for handling or avoiding such collisions.

In the case of a collision between a PRACH transmission and either a PUCCH transmission, an SRS transmission, and/or a PUSCH transmission, the base station may assume that a number of transmit antennas per CC is the same as for a UE that is not capable of dynamically managing UL transmit antennas. Processing may proceed from block 706 to block 708.

At block 708, the base station may receive one or more of the UL transmissions from the UE on one or more of the configured CCs.

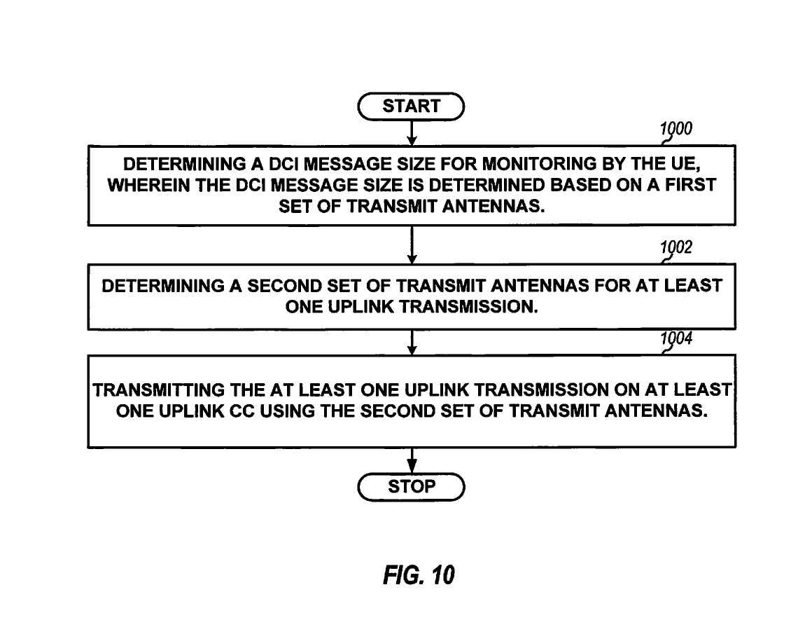

FIG. 10 is a block diagram illustrating example blocks of a wireless communication process carried out by a user equipment to implement one aspect of the present disclosure. At block 1000, a UE determines a DCI message size for monitoring by the UE. The DCI message size is determined by the UE based on a first set of transmit antennas. For example, the DCI size may be based on a size of the maximum number of transmit ports, e.g., four transmit ports, where a transmit port may be directly based on a physical transmit antenna or may be a virtual transmit port mapped from one or more physical transmit antennas. In such aspects, in one example implementation, the information field of precoding information in DCI format 4 may always be assumed as 6 bits, for example. In other DCI formats, the assumed number of bits may be different, with the assumption still being for the number of bits corresponding to the maximum number of transmit ports.

At block 1002, the UE determines a second set of transmit antennas for at least one uplink transmission. The UE configures UL transmissions on one or more UL CCs by assigning one or more UE transmit antennas to each of the one or more CCs. For example, the assignment may be made by the UE as a function of a number of uplink CCs simultaneously involved in the UL transmissions. At block 1004, the UE transmits the uplink transmission on at least one uplink CC using the second set of transmit antennas.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communications, comprising:
determining, by a user equipment (UE), a downlink control information (DCI) message size for monitoring by the UE, wherein the DCI message size is determined based on a first set of transmit antennas;
determining, by the UE, a second set of transmit antennas for at least one uplink transmission; and
transmitting the at least one uplink transmission on at least one uplink component carrier (CC) using the second set of transmit antennas.

2. The method of claim 1, wherein the second set of transmit antennas is determined as a function of a number of uplink CCs simultaneously involved in the at least one uplink transmission.

3. The method of claim 1, wherein the at least one uplink transmission includes one or more of:
physical uplink control channel (PUCCH) transmissions;
sounding reference signal (SRS) transmissions; or
physical uplink shared channel (PUSCH) transmissions.

4. The method of claim 1,
wherein the at least one uplink transmission is a retransmission of a previous uplink transmission, and
wherein the determining the second set of transmit antennas includes determining at least a same number or more transmit antennas as a number of antennas used to transmit the previous uplink transmission.

5. The method of claim 1,
wherein the at least one uplink transmission is a retransmission of a previous uplink transmission, and
wherein the determining the second set of transmit antennas includes determining fewer transmit antennas as a number of antennas used to transmit the previous uplink transmission, wherein the fewer transmit antennas are mapped to a number of virtual antenna ports equal to the number of antennas used to transmit the previous uplink transmission.

6. The method of claim 1, wherein the determining the DCI message size includes determining the DCI message size that maintains a maximum number of blind decoding attempts by the UE of a received DCI message.

7. The method of claim 1, wherein the second set of transmit antennas is determined based on an indication in the DCI message.

8. The method of claim 1, further comprising receiving a configuration of the first set of transmit antennas and the second set of transmit antennas on a semi-static basis.

9. The method of claim 1, further comprising determining a second DCI message size for monitoring by the UE, wherein the second DCI message size is independent of transmit antennas, and wherein the second set of transmit antennas is determined based on an indication in a second DCI message.

10. An apparatus configured for wireless communications, comprising:
means for determining, by a user equipment (UE), a downlink control information (DCI) message size for monitoring by the UE, wherein the DCI message size is determined based on a first set of transmit antennas;
means for determining, by the UE, a second set of transmit antennas for at least one uplink transmission; and
means for transmitting the at least one uplink transmission on at least one uplink component carrier (CC) using the second set of transmit antennas.

11. The apparatus of claim 10, wherein the second set of transmit antennas is determined as a function of a number of uplink CCs simultaneously involved in the at least one uplink transmission.

12. The apparatus of claim 10, wherein the at least one uplink transmission includes one or more of:
physical uplink control channel (PUCCH) transmissions;
sounding reference signal (SRS) transmissions; or
physical uplink shared channel (PUSCH) transmissions.

13. The apparatus of claim 10,
wherein the at least one uplink transmission is a retransmission of a previous uplink transmission, and
wherein the means for determining the second set of transmit antennas includes means for determining at least a same number or more transmit antennas as a number of antennas used to transmit the previous uplink transmission.

14. The apparatus of claim 10,
wherein the at least one uplink transmission is a retransmission of a previous uplink transmission, and
wherein the means for determining the second set of transmit antennas includes means for determining fewer transmit antennas as a number of antennas used to transmit the previous uplink transmission, wherein the fewer transmit antennas are mapped to a number of virtual antenna ports equal to the number of antennas used to transmit the previous uplink transmission.

15. The apparatus of claim 10, wherein the means for determining the DCI message size includes means for determining the DCI message size that maintains a maximum number of blind decoding attempts by the UE of a received DCI message.

16. The apparatus of claim 10, wherein the second set of transmit antennas is determined based on an indication in the DCI message.

17. A computer program product for wireless communications in a wireless network, comprising:
a non-transitory computer-readable medium having program code recorded thereon, the program code including:
program code for causing a computer to determine, by a user equipment (UE), a downlink control information (DCI) message size for monitoring by the UE, wherein the DCI message size is determined based on a first set of transmit antennas;
program code for causing the computer to determine, by the UE, a second set of transmit antennas for at least one uplink transmission; and
program code for causing the computer to transmit the at least one uplink transmission on at least one uplink component carrier (CC) using the second set of transmit antennas.

18. The computer program product of claim 17, wherein the second set of transmit antennas is determined as a function of a number of uplink CCs simultaneously involved in the at least one uplink transmission.

19. The computer program product of claim 17, wherein the at least one uplink transmission includes one or more of:
physical uplink control channel (PUCCH) transmissions;
sounding reference signal (SRS) transmissions; or
physical uplink shared channel (PUSCH) transmissions.

20. The computer program product of claim 17,
wherein the at least one uplink transmission is a retransmission of a previous uplink transmission, and
wherein the program code for causing the computer to determine the second set of transmit antennas includes program code for causing the computer to determine at least a same number or more transmit antennas as a number of antennas used to transmit the previous uplink transmission.

21. The computer program product of claim 17,
wherein the at least one uplink transmission is a retransmission of a previous uplink transmission, and
wherein the program code for causing the computer to determine the second set of transmit antennas includes program code for causing the computer to determine fewer transmit antennas as a number of antennas used to transmit the previous uplink transmission, wherein the fewer transmit antennas are mapped to a number of virtual antenna ports equal to the number of antennas used to transmit the previous uplink transmission.

22. The computer program product of claim 17, wherein the program code for causing the computer to determine the DCI message size includes program code for causing the computer to determine the DCI message size that maintains a maximum number of blind decoding attempts by the UE of a received DCI message.

23. The computer program product of claim 17, wherein the second set of transmit antennas is determined based on an indication in the DCI message.

24. An apparatus configured for wireless communication, the apparatus comprising:
at least one processor; and
a memory coupled to the at least one processor,
wherein the at least one processor is configured:
to determine, by a user equipment (UE), a downlink control information (DCI) message size for monitoring by the UE, wherein the DCI message size is determined based on a first set of transmit antennas;
to determine, by the UE, a second set of transmit antennas for at least one uplink transmission; and
to transmit the at least one uplink transmission on at least one uplink component carrier (CC) using the second set of transmit antennas.

25. The apparatus of claim 24, wherein the second set of transmit antennas is determined as a function of a number of uplink CCs simultaneously involved in the at least one uplink transmission.

26. The apparatus of claim 24, wherein the at least one uplink transmission includes one or more of:
physical uplink control channel (PUCCH) transmissions;
sounding reference signal (SRS) transmissions; or
physical uplink shared channel (PUSCH) transmissions.

27. The apparatus of claim 24,
wherein the at least one uplink transmission is a retransmission of a previous uplink transmission, and
wherein the configuration of the at least one processor to determine the second set of transmit antennas includes configuration of the at least one processor to determine at least a same number or more transmit antennas as a number of antennas used to transmit the previous uplink transmission.

28. The apparatus of claim 24,
wherein the at least one uplink transmission is a retransmission of a previous uplink transmission, and
wherein the configuration of the at least one processor to determine the second set of transmit antennas includes configuration of the at least one processor to determine fewer transmit antennas as a number of antennas used to transmit the previous uplink transmission, wherein the fewer transmit antennas are mapped to a number of virtual antenna ports equal to the number of antennas used to transmit the previous uplink transmission.

29. The apparatus of claim 24, wherein the configuration of the at least one processor to determine the DCI message size includes configuration of the at least one processor to determine the DCI message size that maintains a maximum number of blind decoding attempts by the UE of a received DCI message.

30. The apparatus of claim 24, wherein the second set of transmit antennas is determined based on an indication in the DCI message.
